(19) United States
(12) Patent Application Publication
(10) Pub. No.: US 2010/0125978 A1
(43) Pub. Date: May 27, 2010

(54) HINGE ASSEMBLY AND PORTABLE ELECTRONIC DEVICE USING SAME

(75) Inventor: JIAN MA, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/542,818

(22) Filed: Aug. 18, 2009

(30) Foreign Application Priority Data
Nov. 25, 2008 (CN) 200810305725.6

(51) Int. Cl. E05D 5/10

(52) U.S. Cl. 16/386

(57) ABSTRACT

A hinge assembly used in a portable electronic device includes a hinged portion, an assembled portion and a connecting shaft. The hinged portion is rotatably assembled with the assembled portion by the connecting shaft. One end of the hinged portion defines a blind hole axially recessed therein. The assembled portion defines an assembled through hole there through. The connecting shaft adjustably penetrates through the assembled through hole of the assembled portion and inserts into the blind hole of the hinged portion to adjust the tightness between the hinged portion and the assembled portion. The invention also describes an electronic device using the hinge assembly.

### BACKGROUND

1. Technical Field

The exemplary disclosure generally relates to hinge assemblies, and particularly, to a hinge assembly used in a portable electronic device.

2. Description of Related Art

With the development of technology, portable electronic devices, e.g., mobile phones and personal digital assistants (PDAs) have become widely used. Folding type portable electronic devices are especially popular among consumers.

Folding type portable electronic device usually includes a main body, a cover, and a hinge assembly used to rotatably connect the main body and the cover. However, the conventional hinge assembly is often nonadjustable, thus, may deteriorate after repeatedly usage. Moreover, the conventional hinge assembly has complex structure and is hard to assemble and disassemble.

Therefore, there is room for improvement within the art.

### BRIEF DESCRIPTION OF THE DRAWINGS

Many aspects of the hinge assembly and the portable electronic device using same can be better understood with reference to the following drawings. These drawings are not necessarily drawn to scale, the emphasis instead being placed upon clearly illustrating the principles of the exemplary hinge assembly and the portable electronic device using same. Moreover, in the drawings like reference numerals designate corresponding sections throughout the several views.

FIG. 1 shows an isometric, exploded view of a foldable portable electronic device, in accordance with an exemplary embodiment of the exemplary invention.

FIG. 2 shows a perspective view of the foldable portable electronic device, in accordance with an exemplary embodiment of the exemplary invention.

FIG. 3 shows a cross-sectional view taken along line III-III of FIG. 2, in accordance with an exemplary embodiment of the exemplary invention.

### DETAILED DESCRIPTION

The exemplary hinge assembly is suitable for using in portable electronic devices, e.g., mobile phones and personal digital assistants (PDAs).

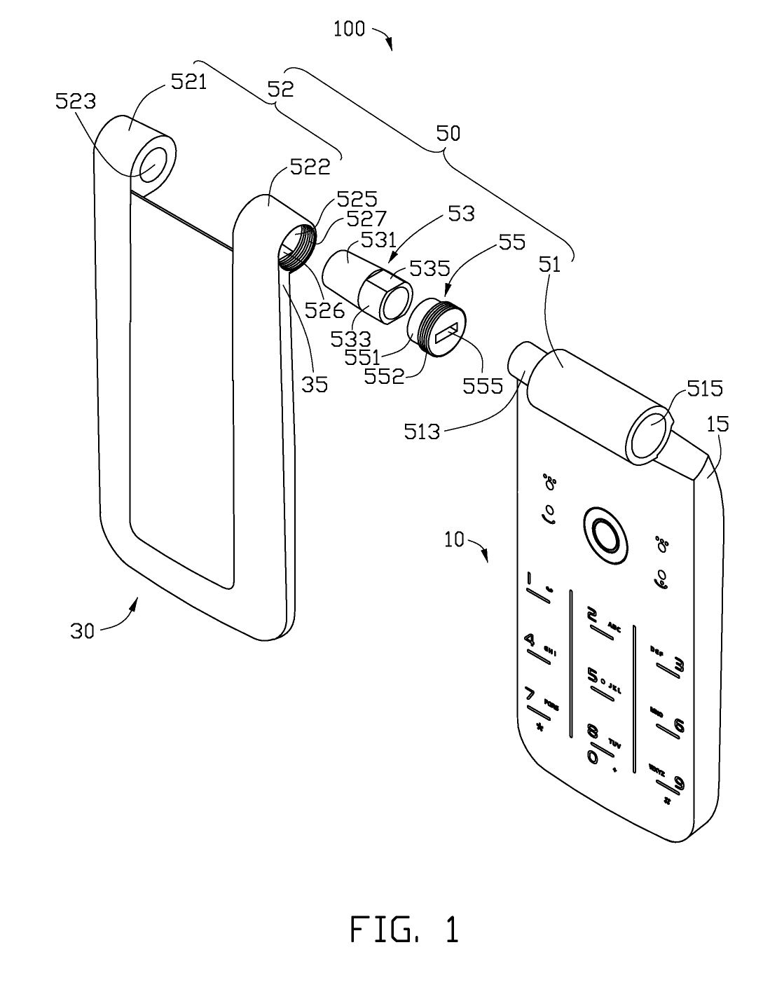

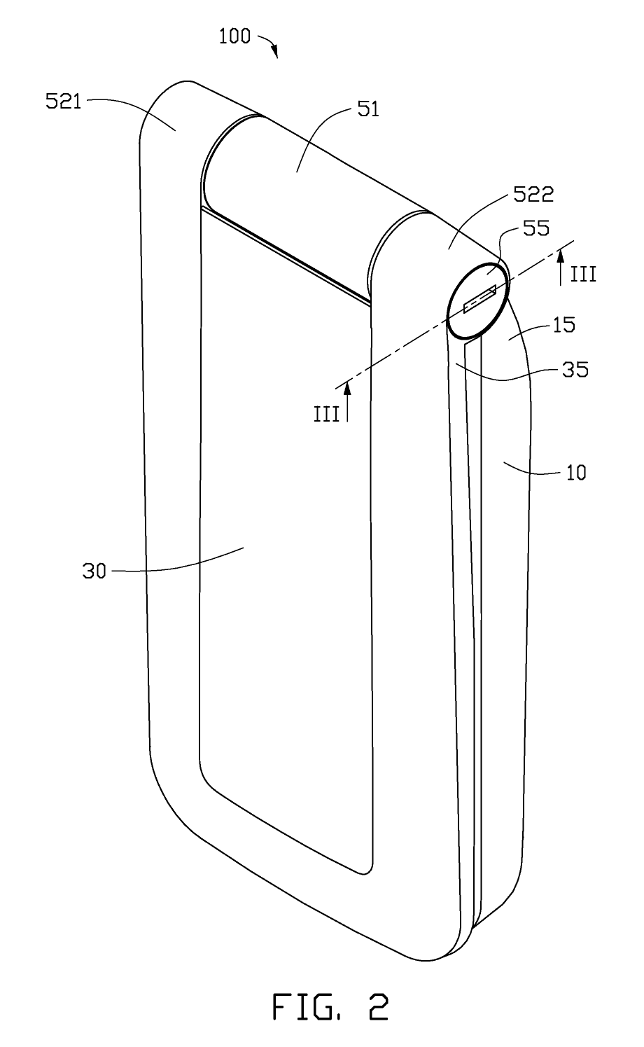

Referring to FIG. 1 and FIG. 2, an exemplary portable electronic device 100 includes a main body 10, a cover 30, and a hinge assembly 50 configured for rotatably connecting the main body 10 and the cover 30. The main body 10 includes a hinged end 15 disposed at one end thereof. The cover 30 includes an assembled end 35 disposed at one end thereof corresponding to the hinged end 15 of the main body 10.

The hinge assembly 50 includes a hinged portion 51, an assembled portion 52, a connecting shaft 53 and an adjusting piece 55. The hinged portion 51 is disposed at the hinged end 15 of the main body 10 and configured for rotatably connecting with the cover 30. The hinged portion 51 may be detachably assembled with the hinged end 15 or integrally formed with the hinged end 15. One end of the hinged portion 51 includes a connecting portion 513 axially protruding outwardly, the opposite end of the hinged portion 51 defines a recessed tapered blind hole 515.

The assembled portion 52 includes a first assembled portion 521 disposed at one side of the assembled end 35 of cover 30 and an opposite second assembled portion 522 disposed at the other side of the assembled end 35 of the cover 30. In the exemplary embodiment, the first assembled portion 521 and the second assembled portion 522 are both cylindrical and spaced, disposed at the two sides of the assembled end 35 of the cover 30, and formed by one forming mold process. The distance between the first assembled portion 521 and the opposite second assembled portion 522 is substantially the same as the axial length of the hinged portion 51. The first assembled portion 521 defines a hinged hole 523 recessed therein axially corresponding to the connecting portion 513 of the hinged portion 51. The second assembled portion 522 defines a substantially cylindrical assembled through hole 525 axially corresponding to the tapered blind hole 515 end of the hinged portion 51. The inner wall of the assembled through hole 525 adjacent the first assembled portion 521 end defines two guiding walls 526 protruding therefrom and axially parallel to each other. The end of the inner wall of the assembled through hole 525 opposite the first assembled portion 521 defines screw threads 527.

The connecting shaft 53 is substantially hollow and is made of elastic material. The connecting shaft 53 includes a tapered shaft end 531 and an opposite cylindrical shaft end 533 corresponding to the tapered blind hole 515 of the hinged portion 51 and the assembled through hole 525 of the second assembled portion 522 respectively. The outer peripheral wall of the cylindrical shaft end 533 defines two parallel fixing planes 535 thereon corresponding to the two guiding walls 526 of the assembled through hole 525.

The adjusting piece 55 is adjustably screwed within the assembled through hole 525 by the screw threads 527. The adjusting piece 55 includes a resisting end 551 and a screwing end 552 opposite to the resisting end 551. The resisting end 551 is configured for resisting on the cylindrical shaft end 533 of the connecting shaft 53 to adjust the tightness between the tapered shaft end 531 and the tapered blind hole 515 of the hinged portion 51. The outer diameter of the resisting end 551 is slightly smaller than the outer diameter of the screwing end 552. The outer peripheral wall of the screwing end 552 defines outer screw threads (not labeled) thereon corresponding to the screw threads 527 of the second assembled portion 522. The cross section of the screwing end 552 defines a groove 555 therein for adjusting the adjusting piece 55.

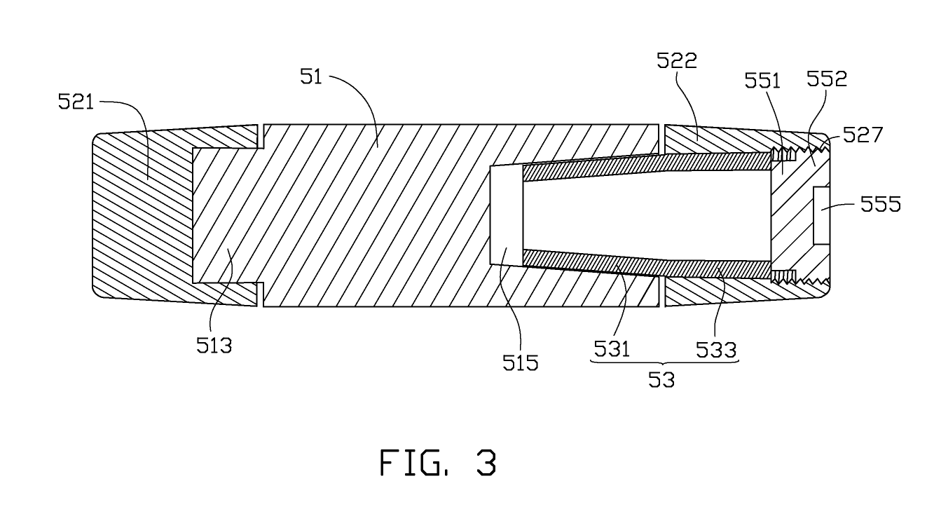

Referring to FIG. 1 and FIG. 3, in assembly, the connecting portion 513 of the hinged portion 51 aligns with and is rotatably inserted into the hinged hole 523 of the first assembled portion 521, thus, the hinged portion 51 of the main body 10 is assembled and accommodated between the first assembled portion 521 and the second assembled portion 522 of the cover 30. The tapered shaft end 531 of the connecting shaft 53 penetrates through the assembled through hole 525 of the second assembled portion 522 and is inserted into the tapered blind hole 515 of the hinged portion 51 so as to rotatably connect the cover 30 with the main body 10. The cylindrical shaft end 533 of the connecting shaft 53 is assembled within the assembled through hole 525 and, the two fixing planes 535 slidably resist against the corresponding two guiding walls 526 of the assembled through hole 525 respectively. The adjusting piece 55 is inserted into the assembled through hole 525 and screws with the screw threads 527 of the assembled through hole 525 to adjust the degree of tightness between the hinged portion 51 of the main body 10 and the assembled portion 52 of the cover 30.

In use, the hinge connecting between the battery cover 30 and the main body 10 may become loose after frequently usage. It can be easily repaired by adjusting the adjusting piece 55. When rotating the adjusting piece 55, the adjusting piece 55 may rotate within the assembled through hole 525 relative to the second assembled portion and move or slide toward the first assembled portion 521 to push the connecting shaft 53. Thus, the tapered shaft end 531 of the connecting shaft 53 may be pushed to tightly connect with the tapered blind hole 515 of the hinged portion 51. The hollow structure of the connecting shaft 53 ensures its elasticity. Additionally, the electronic device 100 using the hinge assembly 50 has simply structure, and is easy to maintain or detach.

It is to be understood that the connecting shaft 53 and the adjusting piece 55 could be made integrally with one forming mold process or omitted. The screw threads could be disposed on the outer peripheral wall of the cylindrical shaft end 533 of the connecting shaft 53.

It is to be understood, however, that even through numerous characteristics and advantages have been set forth in the foregoing description of embodiments, together with details of the structure and functions of the embodiments, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A hinge assembly used in a portable electronic device, comprising:
a hinged portion defining a blind hole axially recessed in one end thereof;
an assembled portion defining an assembled through hole there through and configured for rotatably assembling with the hinged portion; and
a connecting shaft adjustably penetrating through the assembled through hole of the assembled portion and inserted into the hole of the hinged portion to adjust the tightness between the hinged portion and the assembled portion.

2. The hinge assembly as claimed in claim 1, wherein the blind hole of the hinged portion is tapered, the connecting shaft includes a tapered shaft end rotatably hinged with the corresponding tapered blind hole of the hinged portion, and an opposite cylindrical shaft end is adjustably and axially assembled within the corresponding assembled through hole of the assembled portion.

3. The hinge assembly as claimed in claim 2, wherein the hinge assembly further includes an adjusting piece adjustably screwed within the assembled through hole and resists the cylindrical shaft end of the connecting shaft.

4. The hinge assembly as claimed in claim 3, wherein the opposite other end of the hinged portion includes a connecting portion protruding axially outwardly therefrom, the assembling portion includes a first assembled portion and an opposite second assembled portion; the first assembled portion defines a hinged hole axially recessed therein and configured for rotatably assembling with the corresponding connecting portion; the assembled through hole is defined through the assembled portion axially corresponding to the tapered blind hole end of the hinged portion.

5. The hinge assembly as claimed in claim 4, wherein the inner wall of the assembled through hole adjacent the first assembled portion end defines two parallel guiding walls protruding therefrom, the opposite end of the inner wall of the assembled through hole defines screw threads therein; the outer peripheral wall of the cylindrical shaft end defines two parallel fixing planes thereon corresponding to the two guiding walls of the assembled through hole, thus, the connecting shaft is axially slidably assembled within the assembled through hole.

6. The hinge assembly as claimed in claim 5, wherein the adjusting piece includes a resisting end and an opposite screwing end; the resisting end is configured for resisting on the cylindrical shaft end of the connecting shaft to adjust the tightness between the tapered shaft end and the tapered blind hole.

7. The hinge assembly as claimed in claim 6, wherein the outer peripheral wall of the screwing end defines outer screw threads thereon corresponding to the screw threads of the second assembled portion; the cross section of the screwing end defines a groove for adjusting the adjusting piece.

8. The hinge assembly as claimed in claim 7, wherein the outer diameter of the resisting end is slightly less then the outer diameter of the screwing end.

9. The hinge assembly as claimed in claim 1, wherein the connecting shaft is substantially hollow shaped and is made of the elastic material.

10. The hinge assembly as claimed in claim 3, wherein the connecting shaft and the adjusting piece are formed by one forming mold process.

11. A portable electronic device, comprising:
a main body comprising a hinged end disposed at one end thereof,
a cover rotatably comprising an assembled end disposed at one end thereof corresponding to the hinged end of the main body; and
a hinge assembly configured for assembling the cover to the main body rotatably; the hinge assembly comprising:
a hinged portion disposed at the hinged end of the main body, the hinged portion defining a blind hole axially recessed in one end thereof;
an assembled portion disposed at the assembled end of the cover, the assembled portion defining an assembled through hole there through; and
a connecting shaft adjustably penetrating through the assembled through hole of the assembled portion and inserted into the hole of the hinged portion to adjust the tightness between the hinged portion of the main body and the assembled portion of the cover.

12. The portable electronic device as claimed in claim 11, wherein the blind hole of the hinged portion is tapered, the connecting shaft includes a tapered shaft end rotatably hinged with the corresponding tapered blind hole of the hinged portion, and an opposite cylindrical shaft end adjustably assembled with the corresponding assembled through hole of the assembled portion axially.

13. The portable electronic device as claimed in claim 12, wherein the hinge assembly further includes an adjusting piece adjustably screwed within the assembled through hole and resists on the cylindrical shaft end of the connecting shaft.

14. The portable electronic device as claimed in claim 13, wherein the opposite other end of the hinged portion includes a connecting portion protrudes outwardly therefrom, the assembling portion includes a first assembled portion and an opposite second assembled portion; the first assembled portion defines a hinged hole axially recessed therein and configured for rotatably assembling with the corresponding connecting portion; the assembled through hole is defined through the assembled portion axially corresponding to the tapered blind hole end of the hinged portion.

15. The portable electronic device as claimed in claim 14, wherein the inner wall of the assembled through hole adjacent the first assembled portion end defines two guiding walls axially protruding therefrom parallel to each other; the opposite end of the inner wall of the assembled through hole defines screw threads therein; the outer peripheral wall of the cylindrical shaft end defines two fixing planes thereon parallel to each other corresponding to the two guiding walls of the assembled through hole, thus, the connecting shaft is axially slidably assembled within the assembled through hole.

16. The portable electronic device as claimed in claim 15, wherein the adjusting piece is a substantially ladder-shaped shaft and includes a resisting end and an opposite screwing end; the resisting end is configured for resisting on the cylindrical shaft end of the connecting shaft to adjust the tightness between the tapered shaft end and the tapered blind hole.

17. The portable electronic device as claimed in claim 16, wherein the outer peripheral wall of the screwing end defines outer screw threads thereon corresponding to the screw threads of the second assembled portion; the cross section of the screwing end defines a recessed bar shaped groove therein for adjusting the adjusting piece.

18. The portable electronic device as claimed in claim 11, wherein the connecting shaft is substantially hollow shaped and is made of the elastic material.
